(19) United States
(12) Patent Application Publication
(10) Pub. No.: US 2005/0217023 A1
(43) Pub. Date: Oct. 6, 2005

(54) Hospital bed with means for positioning a patient

(75) Inventor: Kevin L. Tally, Clarinda, IA (US)

Correspondence Address: BANNER & WITCOFF, LTD., TEN SOUTH WACKER DRIVE, SUITE 3000, CHICAGO, IL, 60606, US

(73) Assignee: Home Hospital Equipment Company d/b/a EZ Way, Inc., Clarinda, IA (US)

(21) Appl. No.: 10/818,781

(22) Filed: Apr. 6, 2004

(51) Int. Cl. A61G 7/08

(52) U.S. Cl. 5/81.1 HS; 5/81.1 R

(57) ABSTRACT

A patient care bed includes a windlass mechanism for engaging and movement of an elongate sheet to thereby transport or move a patient supported on the sheet. The windlass mechanism includes a hollow tube with a slot into which a retainer mechanism may be fitted to hold the end of the sheet to the hollow tube.

### BACKGROUND OF THE INVENTION

In a principal aspect, the present invention relates to a bed, such as a hospital bed, which includes a mechanism for moving and positioning a patient on the bed.

U.S. Pat. No. 4,799,273, incorporated herewith by reference, discloses a bed, such as a hospital bed, with an arrangement that provides a means for movement of a patient on the mattress or platform of the bed. The bed includes a frame which supports the mattress or platform. A first sheet of material is placed over the top of the mattress or platform. An extra long or extended second sheet is placed over the first sheet and is attached to a windlass, or sheet winding mechanism, situated at one end of the bed, preferably the head end. The second sheet extends from the head end of the bed over the horizontal surface or platform defined by the mattress and into a storage container or hamper at the foot end of the bed which retains the excess length of the second sheet.

By operating the windlass to move or draw the second sheet over the first sheet, one can move or transport a patient lying on the second sheet. The device is especially useful in circumstances where a hospital bed is maintained for a time in an inclined position to facilitate feeding and respiration of a patient. Such a position, however, may cause the patient to slide or slip down the incline formed by the mattress. Thus, upon returning the bed mattress or platform back to a horizontal position, it is necessary to reposition the patient appropriately within the boundaries or confines of the platform or mattress. This is accomplished by operation of the windlass which transports the sheet upon which the patient is resting, typically toward the head end of the bed, thereby moving the patient without a high degree of distress.

Such an assembly is especially useful in hospital situations where geriatric patients, having little ability to move, are located. Such a construction requires attachment of the second or top sheet to the windlass construction. U.S. Pat. No. 4,799,273 discloses a construction wherein the sheet is fitted around a narrow diameter tube and inserted into a larger diameter tube through a slot in the larger tube. Another mechanism for attaching an elongate sheet to the windlass utilizes a hook and loop fastener (Velcro) fitted around the bar or rod upon which the sheet is wound. Use of hook and loop materials, such as Velcro fasteners, however, is not necessarily desirable inasmuch as the hook and loop combination is prone to collect dirt which is undesirable, particularly in a situation requiring a high degree of hygiene. Thus, there has developed a need to provide an improved mechanism and means for joining an elongate sheet to the shaft or rod of a windlass construction associated with a patient movement device or apparatus.

### SUMMARY OF THE INVENTION

Accordingly, the subject matter of the invention comprises a patient care bed of the type described in U.S. Pat. No. 4,799,273 wherein the take up mechanism associated with the top sheet of such a patient bed is comprised of a hollow tube with a slot that is substantially equal to or slightly greater than the width of the top sheet which is to be attached thereto. The slot has dimensions which enable the sheet to be fitted into the slot and a retaining bar or mechanism is then fitted against the sheet and directed into the slot to retain the sheet locked in position with the tube. In a preferred embodiment, the retaining mechanism comprises an elastomeric member section which fits through the slot of the tube and which is retained in the slot by means of its elastomeric characteristics. The retention mechanism or bar may thus be inserted along with the end of the sheet into the slot of the tube to retain the sheet engaged with the tube associated with the windlass or take up mechanism. The take up bar may then be rotated to wind the sheet thereon and thus transport an individual on the sheet over the platform.

Thus, it is an object of the invention to provide an improved patient transport system for a hospital bed.

It is a further object of the invention to provide a mechanism for attaching an elongate sheet to a windlass bar or rod so as to tightly grip the sheet so that it may be wound on the bar while at the same time providing for enhanced hygienic conditions and adequate means for retention of the sheet engaged with the bar or windlass.

Yet another object of the invention is to provide a rugged yet inexpensive mechanism for attaching a sheet to be wound on a windlass shaft.

These and other objects, advantages and features of the invention will be set forth in the detailed description which follows.

### BRIEF DESCRIPTION OF THE DRAWING

In the detailed description which follows, reference will be made to the drawing comprised of the following figures

FIG. 1 is derived from U.S. Pat. No. 4,799,273 and depicts the general overall construction of a preferred embodiment of the invention;

FIG. 2 is a side elevation of the construction of FIG. 1;

FIG. 3 is an isometric view of the windlass tube construction of the present invention as incorporated in a patient bed of the type depicted in FIG. 1;

FIG. 4 is a cross sectional view of the retainer mechanism associated with the tube or take up shaft for the patient care bed of the invention;

FIG. 4A is a side elevation of the retainer of FIG. 4;

FIG. 4B is a top plan view of the retainer of FIG. 4;

FIG. 5 is a top plan view of the tube of the windlass mechanism associated with the invention; and

FIG. 6 is an isometric view of the windlass depicting a number of layers of the elongate sheet wound on the shaft or hollow tube associated with the windlass.

### DESCRIPTION OF THE PREFERRED EMBODIMENT

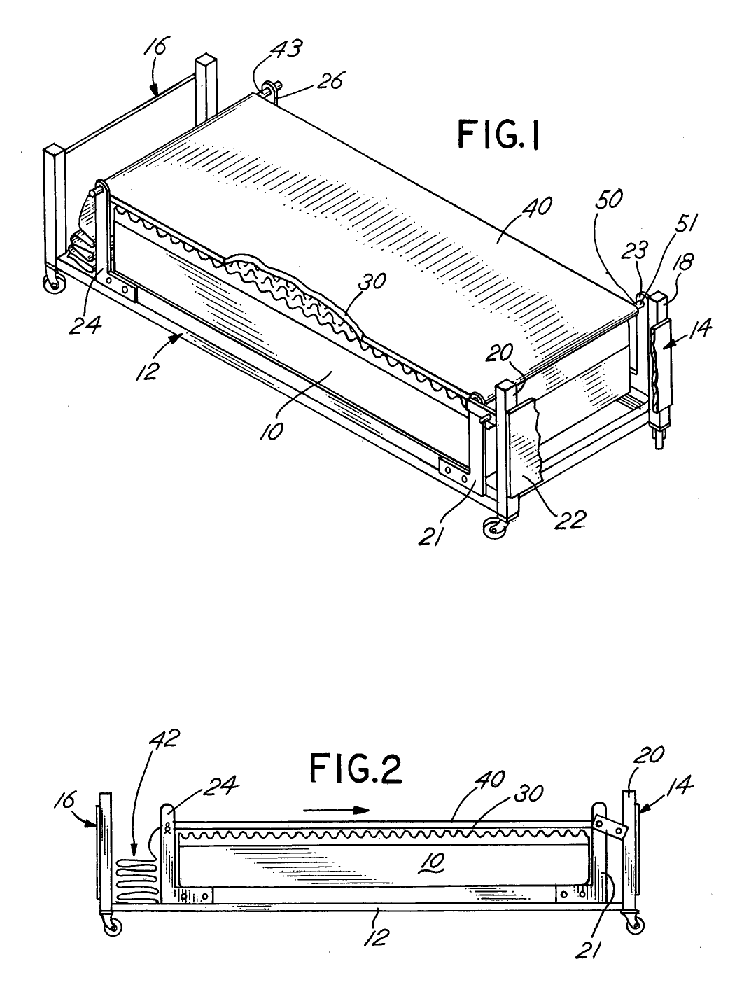

Referring to FIGS. 1 and 2, a patient care bed of the invention comprises a platform or mattress 10 supported on a frame 12. The frame 12 includes a headboard assembly 14 and a footboard assembly 16. Each assembly 14 and 16 is generally comprised of vertical stanchions, such as stanchions 18 and 20, which support a horizontal support board or member 22. The headboard 14 is slightly spaced forward of the mattress 10. In a similar fashion, the footboard 16 is slightly spaced from the bottom end of the mattress 10. Within the space at the forward end or head end of the mattress 10 there is provided a windlass construction which includes a vertical frame member or bracket 21 and 23 positioned respectively on the opposite sides of the mattress 10. In a similar fashion, support brackets 24 and 26 are positioned at the foot end of the mattress 10.

As depicted in FIG. 2, a first sheet 30 of material, such as a canvas material or the like, is fixed between the brackets, or pairs of brackets, 21, 23 and 24, 26. The first sheet 30 is a first sheet which is generally fixed in position on the mattress 10. A second sheet 40 lies over the first sheet 30 and includes an excess length which is folded and fitted into a reservoir or retainer area 42 between the bottom of the mattress 10 or end of the mattress 10 and the footboard 16. The second sheet 40 is attached to a shaft 50 associated with a windlass at the head end of the mattress. The second sheet 40 thus extends from retainer area 42, over a support rod 43 mounted on foot end brackets 24, 26 and is attached to the shaft 50. The shaft 50 is thus mounted for rotation in the vertical brackets 21 and 23.

The mattress 10 and the bed itself may be constructed so that portions of it can be elevated, for example, the head end may be partially elevated. In such a circumstance, a patient lying on the second sheet 40 may inadvertently slide or slip downwardly toward the footboard 16. Note also that upon elevation of the mattress 10 or a part thereof, the second sheet 40 may be partially released from retainer area 42 to accommodate the raising of the mattress 10.

In any event, in order to return the patient who has moved toward the foot end of the bed to a desired position on the mattress 10, the windlass 50 is operated thereby moving the sheet 40 in the direction of the arrow depicted in FIG. 2. This movement transports the patient in a most comfortable manner to the proper position on the mattress or platform 10.

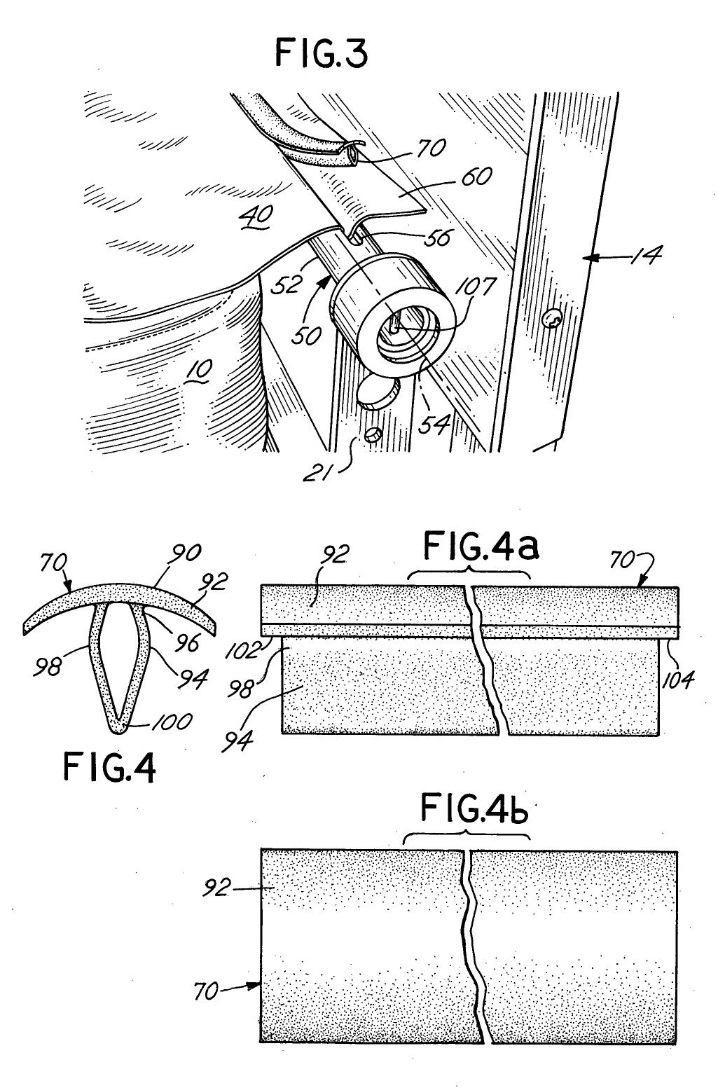

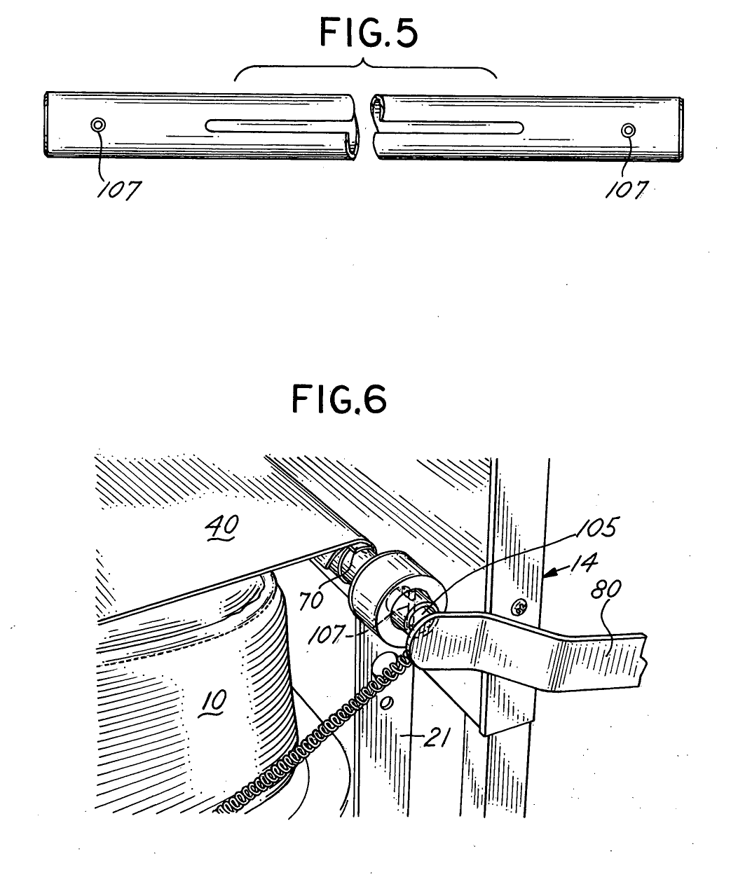

As depicted in FIG. 3, an important feature of the invention is the mechanism for attaching an end 60 of the second sheet 40 to the windlass 50 and, more particularly, to a hollow tube or shaft 52 of the windlass 50. That is, the windlass 50 construction includes a hollow tube 52 which extends horizontally across the head end of the bed or platform. The hollow tube 52 preferably is mounted in bearings (e.g. bearing 51) so tube 52 may be rotatable in spaced brackets 21, 23 on opposite sides of sheet 40. The hollow tube 52 includes a longitudinal axis 54, and a longitudinal axial slot 56 is defined in the hollow tube 52 intermediate the mounting brackets 21, 23. The slot 56 extends transversely the desired movement of sheet 40 and in the direction of the axis 54 and has a dimension that is typically greater than the width of the sheet 40. Thus, the end 60 of the sheet 40 may be folded into slot 56 as depicted in FIG. 3 and a retainer mechanism 70 engaged with the sheet end 60 to hold it in slot 56.

The retainer mechanism or retention device 70 is designed to fit through the slot 56 and retain the end 60 of the sheet 40 within that slot 56 so that upon insertion of a crank or other turning device 80 keyed into the end of the hollow tube 52 and turning the crank 80, the sheet 40 will be wound upon the tube 52. The retention device 70, as depicted in FIGS. 4, 4A and 4B, comprises a high density polyethylene molded or extruded member 90 having an arcuate cap 92 made to conform generally with the outside radiused surface of the tube 52. The retainer 70 further includes a downwardly projecting or radially inwardly projecting retention member 94 which has a narrow dimension at the joinder thereof 96 to the cap 92 and a wider mid-section 98 which is elastically deformable. The retention mechanism further includes a narrowed leading end 100 which facilitates fitting of the retainer member 90 of the retention device 70 into the slot 56 with sheet end 60. Because the retainer 70 is generally elastomeric, the hollow, wide portion of projecting member 94 may be pushed against the sheet end 60 and into the slot 56. The sides of the slot 56 will then fit into the narrowed section 96 and cap 92 will facilitate retention of the retainer 70 on the tube 52.

Then, upon winding of the sheet 40 on the tube 52, the sheet 40 is tightly retained and available for effecting patient movement. The retainer member cap 92 preferably includes lateral end sections 102, 104 which overlie the slot 56 at the opposite ends thereof. The end sections 102 thus fit over and cover the slot 56 in the tube 52. In this manner, the interior of the tube 52 is protected from gathering unhygienic materials.

To remove the retainer 70, one simply grasps one or both of the end caps 102, 104 and pulls the retainer 70 from the slot 56 thereby releasing the end 60 of the second sheet 40. As a consequence, the retainer 70 will be easily inserted and easily removed yet strongly retains the sheet end 60. So retained, the crank 80 may be turned to advance sheet 40. Note crank 80 is keyed to tube 52 and includes a keyed axial projection 105 that slidably fits into the end of hollow tube 52 to engage a compatible key element 107. When inserted and keyed, the crank 80 may be turned. When not needed, the crank 80 may be removed.

While there has been disclosed an embodiment, a second sheet may be omitted from the construction. That is, in the event that a mattress with a pad or without a pad is utilized, the necessity of a sheet over a foam mattress may be eliminated. That is, a single sheet may be provided which will slide or move over the surface of the mattress. When a foam mattress is utilized, however, it may be necessary to use a second sheet in order to avoid undesirable frictional interaction between the foam mattress and the second sheet.

While there has been set forth as a preferred embodiment of the invention, it is to be understood that there are alternatives which may be implemented without departing from the spirit and scope thereof. The invention is therefore to be limited only by the following claims and equivalents thereof.

1. In a patient care bed having a generally horizontal patient support platform, with a longitudinal axis and an end, a support frame for the platform, a surface material on the platform, an elongate sheet overlying the surface and having a first end attachable to a take up mechanism at the end, the improvement comprising a take up mechanism at the end including a tubular member supported transverse to the longitudinal axis, said tubular member including an elongate slot transverse to the longitudinal axis for receipt of the sheet, and
a sheet retention mechanism for retaining the sheet in the elongate slot, said retaining mechanism including a cap section and a projecting slot engaging section whereby the slot engaging section may be inserted in combination with a portion of the sheet through and into the tubular member slot with the cap section maintained outside the tubular member.

2. The improvement of claim 1 wherein the retaining mechanism includes an elastomeric slot engaging section having a first portion with a width greater than the width of the slot and a second portion adjacent the cap less than the width of the first portion.

3. The improvement of claim 1 wherein the cap extends transversely to cover the slot.
